(19) United States
(12) Patent Application Publication
(10) Pub. No.: US 2020/0361382 A1
(43) Pub. Date: Nov. 19, 2020

(54) VEHICULAR VISUAL RECOGNITION DEVICE

(71) Applicant: KABUSHIKI KAISHA TOKAI-RIKA-DENKI-SEISAKUSHO, Aichi (JP)

(72) Inventor: Seiji KONDO, Aichi (JP)

(21) Appl. No.: 16/639,863

(22) PCT Filed: Aug. 13, 2018
(86) PCT No.: PCT/JP2018/030241

§ 371 Date: Feb. 18, 2020

(30) Foreign Application Priority Data
Aug. 21, 2017 (JP) 2017-158735

(51) Int. Cl. B60R 1/08; B60R 1/12; B60K 35/00

(52) U.S. Cl. CPC B60R 1/08; B60R 1/12; B60K 35/00; B60K 2370/176; B60K 2370/779; B60K 2370/167; B60R 2001/1215

(57) ABSTRACT

Provided are a rear camera and a door camera provided at different positions and configured to image vehicle surroundings rearward from a vehicle, and a monitor configured to display a composite image merging captured images captured by the respective cameras and to display a blind spot advisory image to advise of a blind spot in the composite image.

### TECHNICAL FIELD

The present invention relates to a vehicular visual recognition device configured to image vehicle surroundings and display the captured images for visual recognition of vehicle surroundings.

### BACKGROUND ART

Technology is known in which a vehicular visual recognition device that displays captured images of vehicle surroundings is mounted to a vehicle as a substitute for an optical mirror.

For example, in Japanese Patent Application Laid-Open (JP-A) No. 2003-196645, an image A0 captured by a blind spot camera provided at the outside of a vehicle body undergoes viewpoint conversion into an image as if captured from a driver viewpoint position to generate a converted exterior image A2, and a viewpoint image B0 is acquired by a driver viewpoint camera provided near to the driver viewpoint position. A visual recognition region image B1 excluding a blind spot region is generated from the viewpoint image B0.

The converted exterior image A2 is merged with the visual recognition region image B1 to obtain a composite image in which a portion corresponding to the blind spot region has been supplemented. Moreover, a vehicle outline representing the profile of the vehicle is merged with the obtained composite image. This enables concern regarding blind spots to be alleviated.

### SUMMARY OF INVENTION

### Technical Problem

However, in cases in which two or more captured images are merged as in the technology disclosed in JP-A No. 2003-196645, blind spot regions are sometimes present between merged images due to the different positions of the two or more imaging sections. This could lead to the mistaken assumption that everything can be seen in the composite image, and so there is room for improvement in this respect.

In consideration of the above circumstances, an object of the present disclosure is to provide a vehicular visual recognition device capable of making an occupant aware of the presence of a blind spot in a composite image.

### Solution to Problem

In order to achieve the above object, a first aspect includes two or more imaging sections provided at different positions and configured to image surroundings of a vehicle, and a display section configured to display a composite image merging captured images captured by the two or more imaging sections and to display a blind spot advisory image to advise of a blind spot in the composite image.

According to the first aspect, the two or more imaging sections are provided at different positions and are configured to image the surroundings of the vehicle. Note that the two or more imaging sections may perform imaging such that parts of adjacent imaging regions of the two or more imaging sections overlap each other, or abut each other.

The display section is configured to display the composite image merging the captured images captured by the two or more imaging sections. The composite image enables visual recognition of a region in the vehicle surroundings over a wider range than in cases in which a single captured image is displayed. The display section is further configured to display the blind spot advisory image together with the composite image to advise of a blind spot in the composite image. This enables an occupant to be made aware of the presence of the blind spot in the composite image using the blind spot advisory image.

Note that the display section may display the blind spot advisory image alongside the composite image, or may display the blind spot advisory image within the composite image. Alternatively, a blind spot advisory image may be displayed alongside the composite image while also displaying a blind spot advisory image within the composite image.

Moreover, a change section may be further provided to change a merging position of the composite image displayed on the display section in response to at least one vehicle state of vehicle speed, turning or reversing, and to change the blind spot advisory image in response to the change to the merging position. This enables visual recognition of the vehicle surroundings to be improved in response to the vehicle state, and also enables the occupant to be advised of the change in the blind spot region resulting from the change in the merging position using the blind spot advisory image.

Moreover, door imaging sections respectively provided at left and right doors of the vehicle, and a rear imaging section provided at a vehicle width direction central portion of a rear section of the vehicle, may be applied as the two or more imaging sections. The display section may be provided at an interior mirror.

### Advantageous Effects of Invention

As described above, the present invention has the advantageous effect of being capable of providing a vehicular visual recognition device capable of making an occupant aware of the presence of a blind spot in a composite image.

### BRIEF DESCRIPTION OF DRAWINGS

FIG. 1A is a face-on view of relevant portions within a vehicle cabin of a vehicle, as viewed from a vehicle rear side.

FIG. 1B is a plan view of a vehicle provided with a vehicular visual recognition device, as viewed from above.

FIG. 2 is a block diagram illustrating a schematic configuration of a vehicular visual recognition device according to an exemplary embodiment.

FIG. 3A is a schematic diagram illustrating captured images of a vehicle exterior.

FIG. 3B is a schematic diagram illustrating a vehicle cabin image.

FIG. 3C is a schematic diagram illustrating extracted images extracted from respective captured images of a vehicle exterior.

FIG. 3D is a schematic diagram illustrating extracted images extracted from respective captured images of a vehicle exterior.

FIG. 4 is a diagram to explain blind spots present at positions nearer to a vehicle than an imaginary screen.

FIG. 5 is a diagram illustrating an example of a blind spot advisory image displayed next to a composite image.

FIG. 6 is a flowchart illustrating an example of display processing (image display processing) to display a composite image on a monitor, performed by a control device of a vehicular visual recognition device according to the present exemplary embodiment.

FIG. 7A is a diagram illustrating blind spot regions when the position of an imaginary screen is moved when generating composite images.

FIG. 7B is a diagram illustrating blind spot regions when boundary regions for merging are moved when generating composite images.

FIG. 8 is a flowchart illustrating a part of display processing performed by a control device of a vehicular visual recognition device of a modified example (in a case in which composite images are switched in response to vehicle speed).

FIG. 9 is a flowchart illustrating a part of display processing performed by a control device of a vehicular visual recognition device of a modified example (in a case in which composite images are switched in response to turning).

FIG. 10 is a flowchart illustrating a part of display processing performed by a control device of a vehicular visual recognition device of a modified example (in a case in which composite images are switched in response to reversing).

FIG. 11A is a diagram illustrating an example of a hatched image displayed in a composite image.

FIG. 11B is a diagram illustrating an example of a line image displayed in a composite image.

### DESCRIPTION OF EMBODIMENTS

Detailed explanation follows regarding an exemplary embodiment of the present invention, with reference to the drawings.

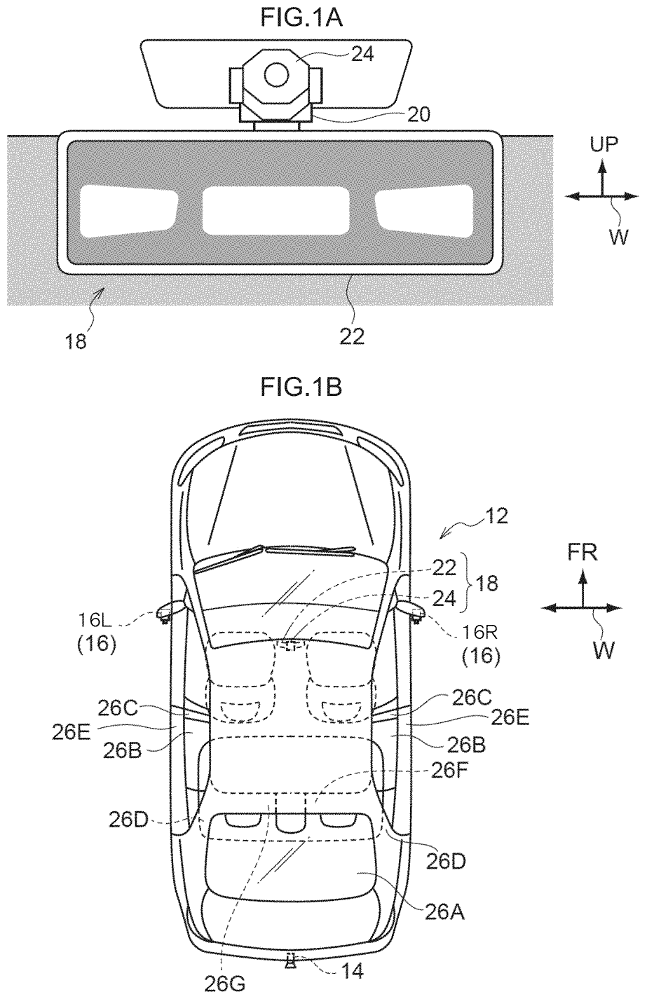

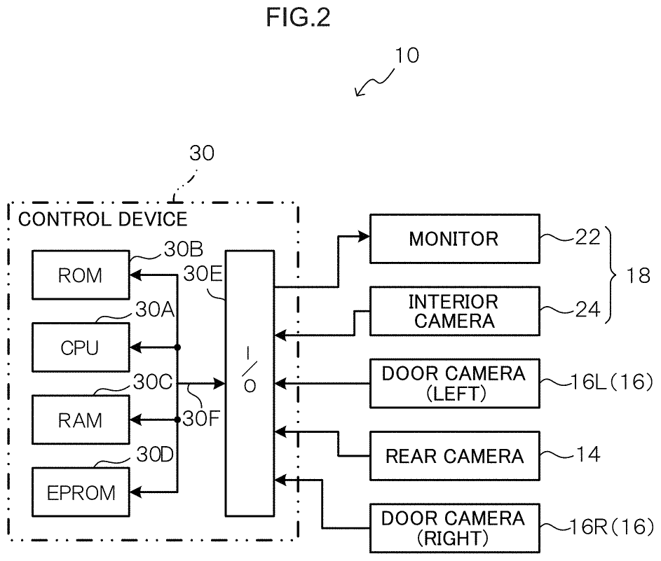

FIG. 1A is a face-on view of relevant portions within a vehicle cabin of a vehicle 12 as viewed from a vehicle rear side, and FIG. 1B is a plan view of the vehicle 12 provided with a vehicular visual recognition device 10 as viewed from above. FIG. 2 is a block diagram illustrating a schematic configuration of the vehicular visual recognition device 10 according to the present exemplary embodiment. Note that in the drawings, the arrow FR indicates a vehicle front side, the arrow W indicates a vehicle width direction, and the arrow UP indicates a vehicle upper side.

The vehicular visual recognition device 10 includes a rear camera 14 serving as an imaging section and a rear imaging section, and door cameras 16L and 16R serving as imaging sections and door imaging sections. The rear camera 14 is disposed at a vehicle width direction central portion of a vehicle rear section (for example, a vehicle width direction central portion of a trunk or a rear bumper) and is capable of imaging rearward from the vehicle 12 over a predetermined view angle (imaging region). The door camera 16L is provided to a vehicle width left side door mirror of the vehicle 12 and the door camera 16R is provided to a vehicle width right side door mirror of the vehicle 12. The door cameras 16L and 16R are capable of imaging rearward from the vehicle from the sides of a vehicle body over predetermined view angles (imaging regions).

The rear camera 14 and the door cameras 16L, 16R image vehicle surroundings rearward from the vehicle. Specifically, portions of the imaging region of the rear camera 14 overlap with portions of the respective imaging regions of the door cameras 16L and 16R, enabling rearward imaging from the vehicle by the rear camera 14 and the door cameras 16L and 16R spanning a range from the oblique rear right of the vehicle body to the oblique rear left of the vehicle body. Rearward imaging from the vehicle 12 is thereby performed over a wide angle.

An interior mirror 18 is provided in the vehicle cabin of the vehicle 12, and a base portion of a bracket 20 of the interior mirror 18 is attached to a vehicle width direction central section of a vehicle front side of a vehicle cabin interior ceiling face. A monitor 22 that has an elongated rectangular shape and that serves as a display section is provided on the bracket 20. The monitor 22 is attached to a lower end portion of the bracket 20 such that the longitudinal direction of the monitor 22 runs in the vehicle width direction and the display screen of the monitor 22 faces toward the vehicle rear. Accordingly, the monitor 22 is disposed in the vicinity of an upper portion of front windshield glass at the vehicle front side, such that the display screen is visible to an occupant in the vehicle cabin.

A half mirror (wide-angle mirror) is provided to the display screen of the monitor 22. When display is not being performed on the monitor 22, the vehicle cabin interior and a rearward field of view through a rear window glass and door window glass are reflected in the half mirror.

An interior camera 24 is provided on the bracket 20. The interior camera 24 is fixed to the bracket 20 at the upper side of the monitor 22 (on the vehicle cabin interior ceiling side). The imaging direction of the interior camera 24 is oriented toward the vehicle rear, such that the interior camera 24 images the vehicle cabin interior and rearward from the vehicle from the vehicle front side.

Rear window glass 26A and door window glass 26B of side doors fall within the imaging region of the interior camera 24, such that the interior camera 24 is capable of capturing the imaging regions of the rear camera 14 and the door cameras 16L and 16R through the rear window glass 26A and the door window glass 26B. Furthermore, center pillars 26C, rear pillars 26D, rear side doors 26E, a rear seat 26F, a vehicle cabin interior ceiling 26Q and the like that are visible in the vehicle cabin interior also fall within the imaging region of the interior camera 24. Note that a front seat may also fall within the imaging region of the interior camera 24.

The vehicular visual recognition device 10 is further provided with a control device 30, serving as a controller and a change section. The rear camera 14, the door cameras 16L and 16R, the monitor 22, and the interior camera 24 are connected to the control device 30. The control device 30 includes a microcomputer in which a CPU 30A, ROM 30B, RAM 30C, a non-volatile storage medium (for example, EPROM) 30D, and an input/output interface (I/O) 30E are connected to one another through a bus 30F. Various programs such as a vehicle visual recognition display control program are stored in the ROM 30B or the like, and the control device 30 displays images on the monitor 22 to assist visual recognition by an occupant by the CPU 30A reading and executing the programs stored in the ROM 30B or the like.

The control device 30 generates a vehicle-exterior image by superimposing captured images of the vehicle-exterior respectively captured by the rear camera 14 and the door cameras 16L and 16R. Further, the control device 30 generates a vehicle cabin image from a captured image captured by the interior camera 24. Furthermore, the control device 30 superimposes the vehicle cabin image on the vehicle-exterior image to generate a composite image for display, and performs control to display the composite image on the monitor 22. Note that the monitor 22 is provided further to the vehicle front side than the driver seat, and the image displayed on the monitor 22 is left-right inverted with respect to the captured images.

The rear camera 14, the door cameras 16L and 16R, and the interior camera 24 capture images from different viewpoint positions to each other. The control device 30 then performs viewpoint conversion processing to match the viewpoint positions of the respective captured images from the rear camera 14, the door cameras 16L and 16R, and the interior camera 24. In the viewpoint conversion processing, for example an imaginary viewpoint is set further to the vehicle front side than the center position of the monitor 22 (an intermediate position in the vehicle width direction and the up-down direction), and the captured images from the rear camera 14, the door camera 16L, the door camera 16R, and the interior camera 24 are each converted into images as if viewed from the imaginary viewpoint. When performing the viewpoint conversion processing, as well as setting the imaginary viewpoint, an imaginary screen is set at the vehicle rear. In the present exemplary embodiment, the imaginary screen is described as if it were a flat surface in order to simplify the explanation; however the imaginary screen may be a curved surface having a convex shape on the vehicle rearward direction side (a curved surface having a concave shape as viewed from the vehicle 12). In the viewpoint conversion processing, any desired method may be applied to convert each captured image into an image projected onto the imaginary screen as viewed from the imaginary viewpoint.

As a result of performing the viewpoint conversion processing based on the same imaginary viewpoint and imaginary screen, the same object appearing in different captured images will appear to overlap itself in the respective captured images. Namely, supposing that an object seen through the rear window glass 26A and the door window glass 26B in the captured image from the interior camera 24 also appears in the captured images from the rear camera 14 and the door cameras 16L and 16R, images of the object would appear to overlap one another. After performing the viewpoint conversion processing, the control device 30 performs trimming processing on each of the captured images from the rear camera 14, the door camera 16L, and the door camera 16R, and extracts images of regions to be displayed on the monitor 22.

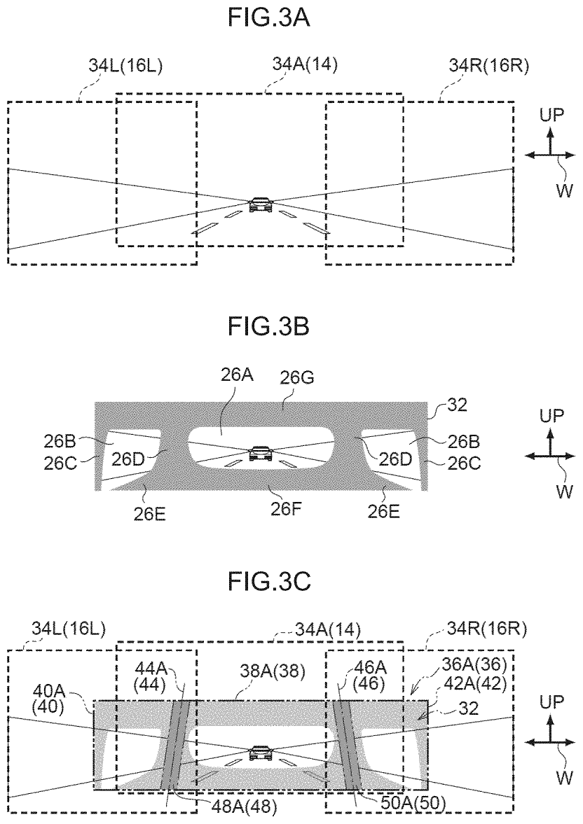

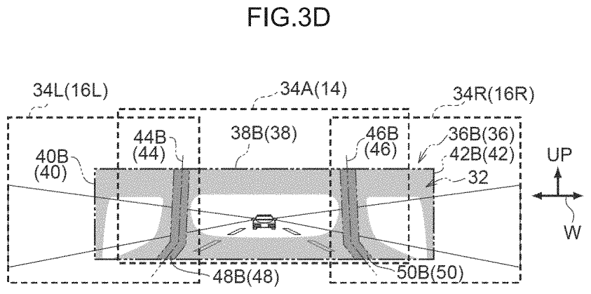

FIG. 3A is a schematic diagram illustrating captured images captured by the rear camera 14 and the door cameras 16L and 16R after the viewpoint conversion processing has been performed. FIG. 3B is a schematic diagram illustrating a vehicle cabin image obtained from the image captured by the interior camera 24 after the viewpoint conversion processing has been performed. Further, FIG. 3C and FIG. 3D are schematic diagrams illustrating extracted regions (extracted images) extracted from the respective captured images from the rear camera 14 and the door cameras 16L and 16R. Note that the vehicle cabin image of FIG. 3B is superimposed thereon in the illustration of FIG. 3C and FIG. 3D. Further, each captured image is illustrated as a rectangular shape as an example.

A vehicle cabin image 32 illustrated in FIG. 3B employs a captured image (video) captured from the vehicle front side inside the vehicle cabin by the interior camera 24 imaging toward the vehicle rear side of the vehicle cabin interior, and the vehicle cabin image 32 is obtained by performing the viewpoint conversion processing on the captured image. The vehicle cabin image 32 includes images at the vehicle exterior as viewed through the rear window glass 26A and the door window glass 26B. The vehicle cabin image 32 further includes images of vehicle body portions such as the center pillars 26C, the rear pillars 26D, the rear side doors 26E, the rear seat 26F, and the vehicle cabin interior ceiling 26G.

As illustrated in FIG. 3A, a captured image 34A from the rear camera 14 is an image of a vehicle width direction region to the rear of the vehicle. Further, a captured image 34L from the door camera 16L is an image of a region at the left side of the captured image 34A as viewed from the vehicle 12, and a captured image 34R from the door camera 16R is an image of a region at the right side of the captured image 34A as viewed from the vehicle 12. An image portion toward the vehicle width left side of the captured image 34A overlaps the captured image 34L, and an image portion toward the vehicle width right side of the captured image 34A overlaps the captured image 34R.

The control device 30 extracts an image of a region to be displayed as the vehicle cabin image 32 on the monitor 22 by performing trimming processing on the captured image from the interior camera 24. Further, the control device 30 sets the transparency of the vehicle cabin image 32 and performs image conversion such that the vehicle cabin image 32 becomes the set transparency. Increasing the transparency of the vehicle cabin image 32 makes the vehicle cabin image 32 appear less opaque and thus more transparent, such that the image appears fainter (appears paler) than in cases in which the transparency is low. The control device 30 sets the transparency of the vehicle cabin image 32 to a transparency enabling a vehicle-exterior image 36, described below, to be made visible in the composite image. Further, in comparison to images of other vehicle body portions in the vehicle cabin image 32, the control device 30 sets a lower transparency (such that the image appears more solid) for the images of the rear pillars 26D, portions of an image of the vehicle cabin interior ceiling 26G at the upper side of the rear pillars 26D, and portions of an image of the rear seat 26F at the lower side of the rear pillars 26D.

Note that the transparency of the images of the rear window glass 26A and the door window glass 26B may be 100% (completely transparent), or may be a similar transparency to the transparency of images of vehicle body portions other than the rear pillars 26D. Further, in the present exemplary embodiment, in addition to the rear pillars 26D, portions of the image of the vehicle cabin interior ceiling 26G at the upper side of the rear pillars 26D, and portions of images of the rear side doors 26E and the rear seat 26F at the lower side of the rear pillars 26D are also included as images of vehicle body components set with a low transparency.

The control device 30 performs trimming processing on the respective captured images 34A, 34L, and 34R from the rear camera 14, the door camera 16L, and the door camera 16R to extract images of regions to be displayed on the monitor 22.

An imaginary boundary line 44 is set between an extracted image 38 extracted from the captured image 34A and an extracted image 40 extracted from the captured image 34L, and an imaginary boundary line 46 is set between the extracted image 38 extracted from the captured image 34A and an extracted image 42 extracted from the captured image 34R. Further, the control device 30 sets regions of predetermined widths on each side of the boundary lines 44 and 46 as merging regions 48 and 50.

The boundary lines 44 and 46 are not limited to straight lines set at positions overlapping the rear pillars 26D in the vehicle cabin image 32. As long as at least part of the boundary lines 44 and 46 overlap images of vehicle body portions other than the rear window glass 26A and the door window glass 26B in the vehicle cabin image 32, the boundary lines 44 and 46 may be curved into curved lines or may be bent. FIG. 3C illustrates a case in which straight line shaped boundary lines 44A and 46A are employed as the boundary lines 44 and 46, and FIG. 3D illustrates a case in which bent boundary lines 44B and 46B are employed as the boundary lines 44 and 46.

As illustrated in FIG. 3C, the boundary line 44A is set in the vehicle cabin image 32 at a position overlapping the rear pillar 26D at the vehicle width left side and the boundary line 46A is set in the vehicle cabin image 32 at a position overlapping the rear pillar 26D at the vehicle width right side. The vehicle width direction positions of the boundary lines 44A and 46A in the vehicle cabin image 32 are set at positions substantially at the center of the rear pillars 26D.

A merging region 48A (48) is set centered on the boundary line 44A and a merging region 50A (50) is set centered on the boundary line 46A. Further, the widths (vehicle width direction dimensions) of the merging regions 48A and 50A in the vehicle cabin image 32 are set either substantially the same as the widths (vehicle width direction dimensions) of the images of the rear pillars 26D, or narrower than the widths of the images of the rear pillars 26D.

An extracted image 38A (38) extracted from the captured image 34A corresponds to a region spanning from the merging region 48A to the merging region 50A (including the merging regions 48A and 50A). Further, an extracted image 40A extracted from the captured image 34L extends as far as the merging region 48A (including the merging region 48A) on the extracted image 38A side, and an extracted image 42A extracted from the captured image 34R extends as far as the merging region 50A (including the merging region 50A) on the extracted image 38A side. The extracted images 38A, 40A, and 42A are superimposed on each other and merged at the merging regions 48A and 50A. This generates a vehicle-exterior image 36A (36) configured by stitching together the extracted images 38A, 40A, and 42A at the merging regions 48A and 50A.

The boundary lines 44B and 46B illustrated FIG. 3D are set in the vehicle cabin image 32 at positions overlapping with the images of the rear pillars 26D, and the boundary lines 44B and 46B bend toward the vehicle front side such that their lower sides overlap the images of the rear side doors 26E. Further, a merging region 48B (48) is set centered on the boundary line 44B and a merging region 50B (50) is set centered on the boundary line 46B. The widths of the merging regions 48B and 50B are set such that the portions thereof overlapping the images of the rear pillars 26D in the vehicle cabin image 32 are either substantially the same as the widths of the images of the rear pillars 26D or narrower than the widths of the images of the rear pillars 26D.

An extracted image 38B (38) extracted from the captured image 34A corresponds to a region spanning from the merging region 48B to the merging region 50B (including the merging regions 48B and 40B). Further, an extracted image 40B extracted from the captured image 34L extends as far as the merging region 48B (including the merging region 48B) on the extracted image 38B side, and an extracted image 42B extracted from the captured image 34R extends as far as the merging region 50B (including the merging region 50B) on the extracted image 38B side. The extracted images 38B, 40B, and 42B are superimposed on each other and merged at the merging regions 48B and 50B. This generates a vehicle-exterior image 36B (36) configured by stitching together the extracted images 38B, 40B, and 42B at the merging regions 48A and 50A.

Further, the control device 30 generates a composite image by superimposing the images of the vehicle body portions in the vehicle cabin image 32 (the images of the rear pillars 26D) on the merging regions 48 and 50 of the vehicle-exterior image 36 (36A and 36B), and merging the vehicle-exterior image 36 with the vehicle cabin image 32. Namely, in the composite image, the extracted images 38, 40, and 42 are superimposed (merged) and stitched together at the merging regions 48 and 50, the images of the rear pillars 26D of the vehicle cabin image 32 are superimposed on the merging regions 48 and 50, and the extracted images 38, 40, and 42 and the vehicle cabin image 32 are merged.

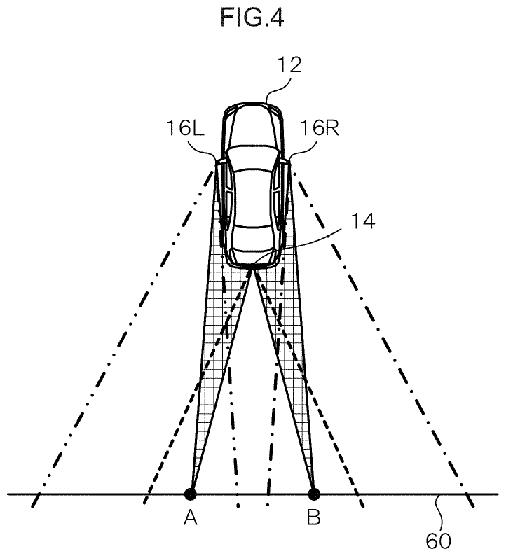

However, when three captured images are merged and displayed as in the present exemplary embodiment, although this enables visual recognition over a wide range, blind spots are present corresponding to positions nearer to the vehicle 12 than the imaginary screen used when merging the images. FIG. 4 is a plan view illustrating blind spot regions present at positions nearer to the vehicle 12 than the imaginary screen as viewed from above.

Specifically, as illustrated in FIG. 4, the range illustrated by double-dotted dashed lines is an imaging range of the door camera 16L, the range illustrated by single-dotted dashed lines is an imaging range of the door camera 16R, and the range illustrated by dotted lines is an imaging range of the rear camera 14. In FIG. 4, boundaries where the captured images from each camera are merged on an imaginary screen 60 are labeled position A and position B. In this case, there are no blind spot regions present in the composite image of the respective captured images on the imaginary screen 60, such that the entire region is displayed. However, the regions indicated by hatching in FIG. 4 correspond to blind spots at positions nearer to the vehicle 12 than the imaginary screen 60. Namely, the captured images from the door cameras 16 that are cropped for merging capture view angle ranges spanning from the respective positions of the positions A, B on the imaginary screen 60 and across the imaging ranges at the vehicle outer sides of the respective door cameras 16L, 16R. The captured image from the rear camera 14 that is cropped for merging captures a view angle range indicated by solid lines spanning from the position A to the position B on the imaginary screen 60. Namely, regions within the captured images indicated by the hatching in FIG. 4 are not represented in the composite image, and so configure blind spots. Since the occupant sees the composite image as merged on the imaginary screen 60, there is a risk that the occupant might not realize the presence of these blind spots. Thus, in the present exemplary embodiment, a blind spot advisory image to advise of the blind spots in the composite image is displayed on the monitor 22 in addition to the display of the composite image.

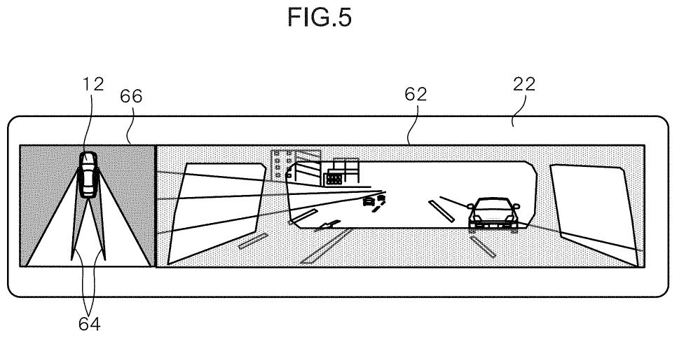

FIG. 5 illustrates an example of a blind spot advisory image in which a blind spot advisory image 66 illustrating blind spot regions 64 with respect to the vehicle 12 is displayed next to a composite image 62. This enables the occupant to be advised of the presence of blind spot regions by the blind spot advisory image 66.

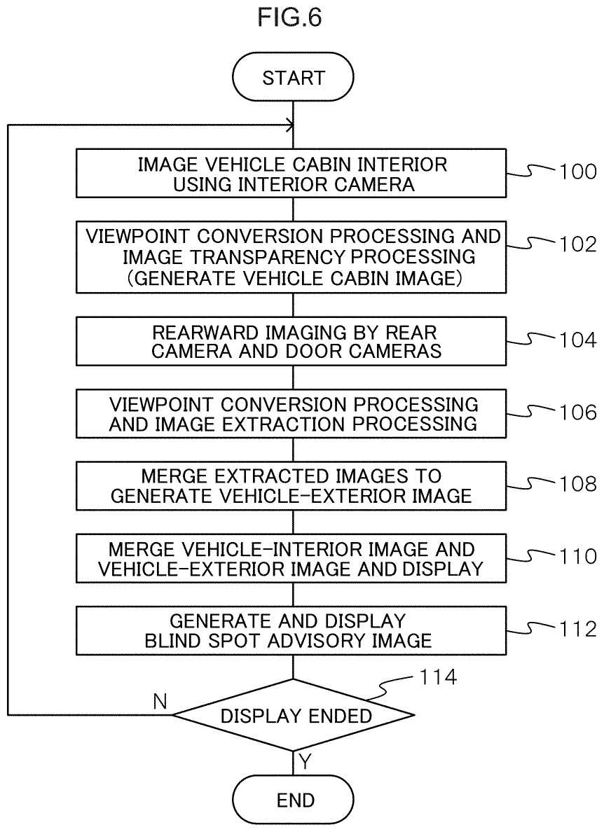

Next, explanation follows regarding specific processing performed by the control device 30 of the vehicular visual recognition device 10 according to the present exemplary embodiment configured as described above. FIG. 6 is a flowchart illustrating an example of display processing (image display processing) of a composite image for the monitor 22 performed by the control device 30 of the vehicular visual recognition device 10 according to the present exemplary embodiment. The processing in FIG. 6 starts when a non-illustrated ignition switch (IG) has been switched ON. Alternatively, the processing may start when display is instructed using a switch provided to switch the monitor 22 between display and non-display. In such cases, image display on the monitor 22 starts when the switch is switched ON, and image display on the monitor 22 is ended and the monitor 22 functions as a rear-view mirror (half mirror) when the switch is switched OFF.

At step 100, the interior camera 24 images the vehicle cabin interior and the CPU 30A reads the captured image of the vehicle cabin interior. Processing then transitions to step 102.

At step 102, the CPU 30A performs viewpoint conversion processing (including trimming processing) on the captured image of the vehicle cabin interior, converts the captured image to a preset transparency, and generates a vehicle cabin image 32. Processing then transitions to step 104.

At step 104, the rear camera 14 and the door cameras 16L, 16R each capture images and the CPU 30A reads the captured images of the vehicle exterior, then processing transitions to step 106.

At step 106, the CPU 30A performs viewpoint conversion processing on the captured images of the vehicle exterior to generate captured images 34A, 34L, 34R, and performs image extraction processing (trimming processing) and the like on the captured images 34A, 34L, 34R. Processing then transitions to step 108.

At step 108, the CPU 30A merges the images extracted by the trimming processing to generate a vehicle-exterior image 36. Processing then transitions to step 110.

At step 110, the CPU 30A merges the vehicle-exterior image 36 and the vehicle cabin image 32, and displays a composite image 62 on the monitor 22 as illustrated in FIG. 5. Processing then transitions to step 112.

At step 112, the CPU 30A generates a blind spot advisory image 66 and displays the blind spot advisory image 66 next to the composite image 62 displayed on the monitor 22 as illustrated in FIG. 5. Processing then transitions to step 114. This enables the occupant to realize the presence of blind spots based on the blind spot advisory image 66, thereby prompting caution.

At step 114, the CPU 30A determines whether or not display on the monitor 22 has ended. This determination is made based on whether or not the ignition switch has been switched OFF, or whether or not the switch for the monitor 22 has been used to instruct non-display. In cases in which a negative determination is made, processing returns to step 100 and the above-described processing is repeated. In cases in which an affirmative determination is made, the display processing routine is ended.

In the present exemplary embodiment, displaying the blind spot advisory image 66 together with the composite image 62 on the monitor 22 in this manner enables the occupant to be made aware of the presence of blind spots in the composite image 62.

However, the blind spot regions in the composite image 62 change according to a merging position (based on at least one position out of the position of the imaginary screen 60 and merging boundary positions (positions A and B in FIG. 4)).

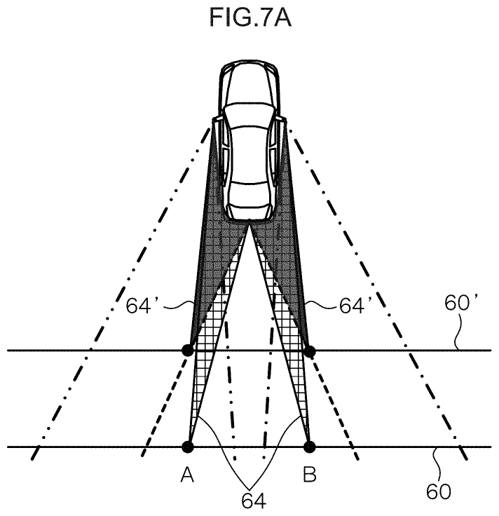

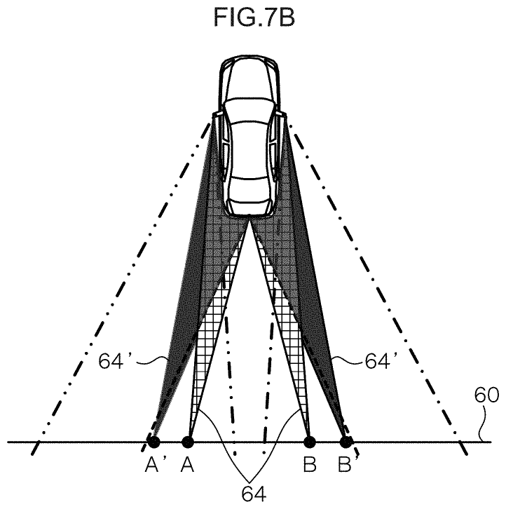

For example, as illustrated in FIG. 7A, when the imaginary screen 60 is moved to a position nearer to the vehicle (to an imaginary screen 60′) to generate a composite image 62, the hatched blind spot regions 64 in FIG. 7A change to the black blind spot regions 64′.

As illustrated in FIG. 7B, when the boundary positions (positions A and B) of the respective captured images on the imaginary screen 60 are moved to positions further toward the vehicle outer side (positions A′ and B′) to generate a composite image 62, the hatched blind spot regions 64 in FIG. 7B change to the black blind spot regions 64′.

For example, the merging position (at least one position out of the position of the imaginary screen 60 and boundary positions for merging) is changed in response to at least one vehicle state of speed, turning or reversing, thereby switching between composite images 62. When switching between the composite images 62, the blind spot regions change, and so the blind spot advisory image displayed may be changed in order to communicate the change in the blind spot regions. Note that although examples are given below in which either the position of the imaginary screen 60 or the boundary positions for merging are changed when changing the merging position, configuration may be made in which both the position of the imaginary screen 60 and the boundary positions for merging are changed.

For example, the displayed composite image 62 may be switched and the displayed blind spot advisory image 66 may be changed accordingly in response to whether or not the vehicle speed is a high speed corresponding to a predetermined vehicle speed or above. For example, a composite image 62 merged based on imaginary screen 60 that is further away from the vehicle in FIG. 7A may be applied as a composite image 62 for travel at high speed, and a composite image 62 merged based on the imaginary screen 60′ that is closer to the vehicle in FIG. 7A may be applied as a composite image 62 for travel at low speed. Alternatively, one set of boundaries in FIG. 7B may be used to configure a composite image 62 for travel at high speed, and the other set of boundaries in FIG. 7B may be used to configure a composite image 62 for travel at low speed.

Alternatively, the displayed composite image 62 may be switched and the displayed blind spot advisory image 66 may be changed accordingly in response to whether or not the vehicle is turning. In such cases, for example, a composite image 62 configured using the boundary positions further to the vehicle outer side (positions A′ and B′) in FIG. 7B is displayed during normal travel, and a composite image 62 configured using the boundary positions further to the vehicle inside (positions A and B) in FIG. 7B in the turning direction is displayed as the composite image 62 when turning.

Alternatively, the displayed composite image 62 may be switched and the displayed blind spot advisory image 66 may be changed accordingly in response to whether or not the vehicle is reversing. For example, similarly to the composite image 62 for travel at low speed, a composite image 62 merged based on the imaginary screen 60′ that is closer the vehicle may be applied as a composite image 62 for reversing, and similarly to the composite image 62 for travel at high speed, a composite image 62 merged based on the imaginary screen 60 that is further away from the vehicle may be applied as a composite image 62 other than when reversing.

Next, explanation follows regarding specific processing performed by the control device 30 in vehicular visual recognition devices of modified examples.

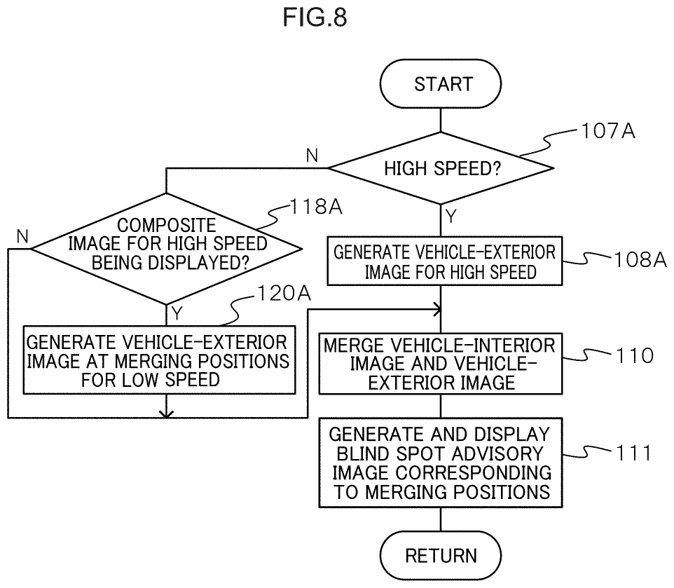

First, explanation follows regarding processing when switching between display of a composite image 62 for travel at high speed and a composite image 62 for travel at low speed in response to the vehicle speed. FIG. 8 is a flowchart illustrating a part of display processing (when switching between composite images 62 in response to the vehicle speed) performed by the control device 30 of a vehicular visual recognition device of a modified example. Note that the processing in FIG. 8 is performed instead of steps 108 to 112 of the processing in FIG. 6.

At step 107A, the CPU 30A determines whether or not the vehicle is traveling at high speed. This determination is for example made based on whether or not a vehicle speed obtained from a vehicle speed sensor provided to the vehicle is a predetermined threshold value or above. In cases in which an affirmative determination is made, processing transitions to step 108A. In cases in which a negative determination is made, processing transitions to step 118A.

At step 108A, the CPU 30A merges the captured images from the respective cameras at the merging position for high speed travel to generate a vehicle-exterior image 36. Processing then transitions to step 110.

At step 110, the CPU 30A merges the vehicle-exterior image 36 and the vehicle cabin image 32 and displays the composite image 62 on the monitor 22. Processing then transitions to step 111.

At step 111, the CPU 30A generates and displays the blind spot advisory image 66 corresponding to the merging positions. The processing then transitions to return to step 114 described previously.

At step 118A, the CPU 30A determines whether or not the composite image 62 for travel at high speed is being displayed. In cases in which an affirmative determination is made, processing transitions to step 120A, and in cases in which a negative determination is made, processing transitions to step 110.

At step 120A, the CPU 30A merges the captured images from the respective cameras at the merging position for travel at low speed and generates a vehicle-exterior image 36. Processing then transitions to step 110.

In this manner, the merging position is changed in response to the vehicle speed and displayed on the monitor 22 as a result of the processing performed by the control device 30, thereby enabling a visual recognition range that is suited to the vehicle speed to be displayed. Moreover, the occupant can be made aware of the change in the blind spot regions resulting from the change in the merging positions using the blind spot advisory image 66.

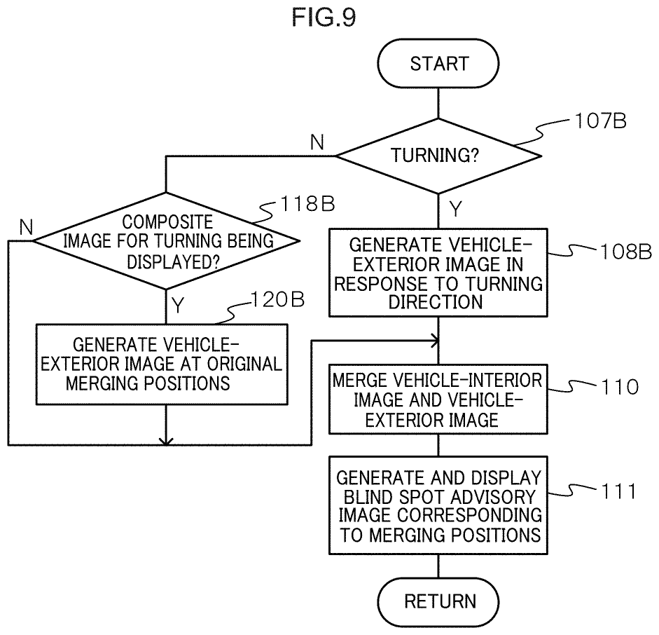

Next, explanation follows regarding processing when switching between display of composite images in response to turning. FIG. 9 is a flowchart illustrating a part of display processing (when switching between composite images 62 in response to turning) performed by the control device 30 of a vehicular visual recognition device of a modified example. Note that the processing in FIG. 9 is performed instead of steps 108 to 112 of the processing in FIG. 6.

At step 107B, the CPU 30A determines whether or not the vehicle is turning. This determination is for example made based on whether or not a direction indicator provided to the vehicle has been operated, or whether or not a steering angle of a predetermined angle or above has been detected by a steering angle sensor. In cases in which an affirmative determination is made, processing transitions to step 108B. In cases in which a negative determination is made, processing transitions to step 118B.

At step 108B, the CPU 30A generates a vehicle-exterior image 36 in response to the turning direction. Processing then transitions to step 110. Namely, the CPU 30A changes the merging positions of the captured images from the respective cameras in response to the turning direction to generate the vehicle-exterior image 36.

At step 110, the CPU 30A merges the vehicle-exterior image 36 and the vehicle cabin image 32 and displays the composite image 62 on the monitor 22. Processing then transitions to step 111.

At step 111, the CPU 30A generates and displays the blind spot advisory image 66 corresponding to the merging positions. The processing then transitions to return to step 114 described previously.

At step 118B, the CPU 30A determines whether or not the composite image 62 for turning is being displayed. In cases in which an affirmative determination is made, processing transitions to step 120B, and in cases in which a negative determination is made, processing transitions to step 110.

At step 120B, the CPU 30A returns the boundary positions for the captured images from the respective cameras to their original positions, and merges the captured images to generate a vehicle-exterior image 36. Processing then transitions to step 110.

In this manner, the merging position is changed in response to turning and displayed on the monitor 22 as a result of the processing performed by the control device 30, thereby enabling visual recognition to be improved when turning. Moreover, the occupant can be made aware of the change in the blind spot regions resulting from the change in the merging positions using the blind spot advisory image.

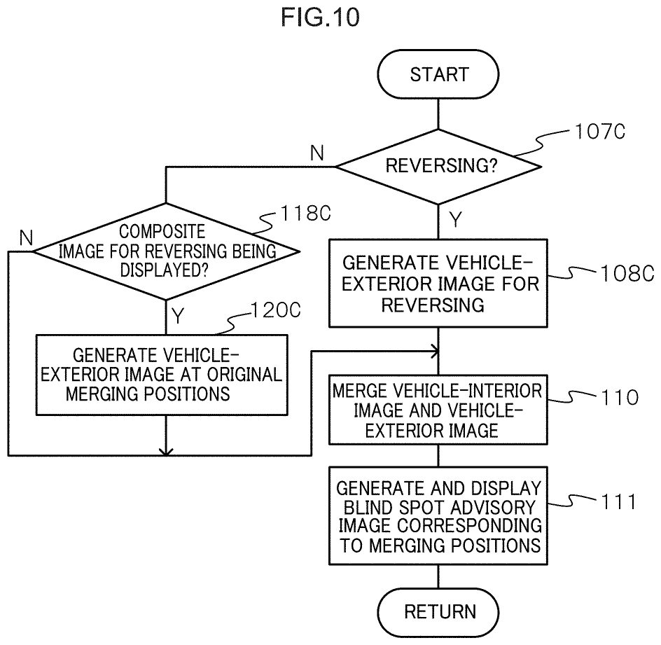

Next, explanation follows regarding processing when switching between display of composite images in response to reversing. FIG. 10 is a flowchart illustrating a part of display processing (when switching between composite images 62 in response to reversing) performed by the control device 30 of a vehicular visual recognition device of a modified example. Note that the processing in FIG. 10 is performed instead of steps 108 to 112 of the processing in FIG. 6.

At step 107C, the CPU 30A determines whether or not the vehicle is reversing. This determination is for example made based on a signal from a reverse switch or a shift position sensor provided to the vehicle. In cases in which an affirmative determination is made, processing transitions to step 108C. In cases in which a negative determination is made, processing transitions to step 118C.

At step 108C, the CPU 30A merges the captured images from the respective cameras at a merging position for reversing to generate a vehicle-exterior image 36. Processing then transitions to step 110.

At step 110, the CPU 30A merges the vehicle-exterior image 36 and the vehicle cabin image 32 and displays the composite image 62 on the monitor 22. Processing then transitions to step 111.

At step 111, the CPU 30A generates and displays the blind spot advisory image 66 corresponding to the merging positions. The processing then transitions to return to step 114 described previously.

At step 118C, the CPU 30A determines whether or not the composite image 62 for reversing is being displayed. In cases in which an affirmative determination is made, processing transitions to step 120C, and in cases in which a negative determination is made, processing transitions to step 110.

At step 120C, the CPU 30A returns the merging positions for the captured images from the respective cameras to their original positions, and merges the captured images to generate a vehicle-exterior image 36. Processing then transitions to step 110.

In this manner, the merging position is changed in response to reversing and displayed on the monitor 22 as a result of the processing performed by the control device 30, thereby enabling visual recognition to be improved when reversing. Moreover, the occupant can be made aware of the change in the blind spot regions resulting from the change in the merging positions using the blind spot advisory image.

Note that although the processing of FIG. 8 (in which display is performed using merging positions changed in response to vehicle speed), the processing of FIG. 9 (in which display is performed using merging positions changed in response to turning), and the processing of FIG. 10 (in which display is performed using merging positions changed in response to reversing) are explained as separate processing in the above modified examples, a mode including all of this processing may be applied. Namely, the merging position may be changed and the blind spot advisory image 66 displayed may be changed in response to at least one vehicle state of vehicle speed, turning or reversing.

Moreover, in the above exemplary embodiment and modified examples, examples have been given in which an image (video image) captured by the interior camera 24 is employed as the vehicle cabin image 32. However, the vehicle cabin image 32 is not limited thereto. For example, an image of the vehicle cabin interior captured in advance in the factory during manufacture or shipping of vehicle, or an image captured prior to the vehicle starting to travel may be employed as the vehicle cabin image 32. Moreover, the vehicle cabin image 32 is not limited to being an image captured by a camera, and an illustration or the like depicting the vehicle cabin interior may be employed. Alternatively, the vehicle cabin image 32 may be omitted from display.

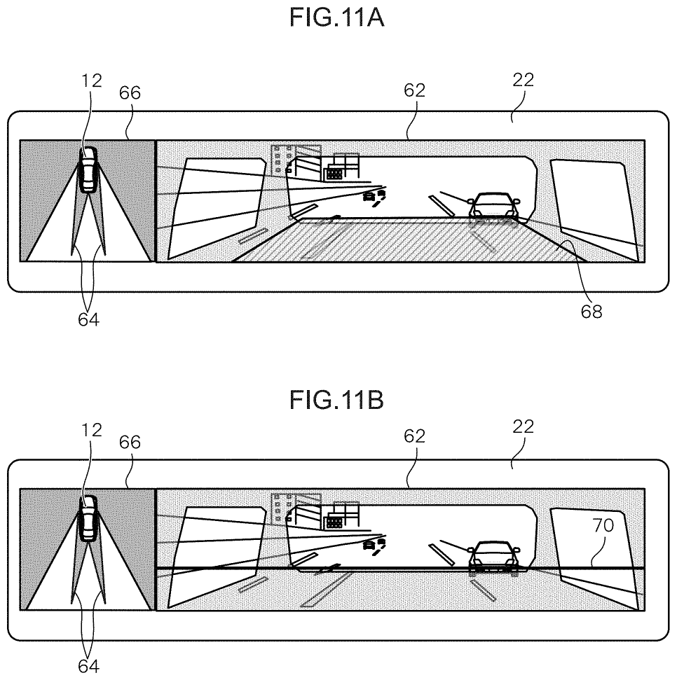

Moreover, in the above exemplary embodiment and modified examples, examples have been given in which the blind spot advisory image 66 is displayed alongside the composite image 62. However, in addition to the blind spot advisory image 66, an image inferring a region in which blind spot regions are present may be displayed within the composite image 62. For example, as illustrated in FIG. 11A, a hatched image 68 may be displayed at a region where a blind spot region is present in the composite image 62. Alternatively, as illustrated in FIG. 11B, a line image 70 may be displayed to advise that a blind spot region is present at the near side of the line image 70. Alternatively, a configuration may be applied in which only the hatched image 68 or the line image 70 is displayed as the blind spot advisory image 66. Note that the hatched image 68 or the line image 70 are preferably displayed in eye-catching colors.

Moreover, in the above exemplary embodiment and modified examples, examples have been given in which three captured images are merged to generate the composite image 62. However, there is no limitation thereto. For example, a mode may be applied in which two images captured at different imaging positions are merged to generate a composite image, or a mode may be applied in which four or more images captured at different imaging positions are merged to generate a composite image.

Moreover, in the above exemplary embodiment and modified examples, examples have been given in which parts of adjacent imaged regions captured by the three cameras, these being the door cameras 16L, 16R and the rear camera 14, overlap each other. However, there is no limitation thereto, and adjacent imaged regions may abut each other. Alternatively, adjacent imaged regions may be spaced discretely without any overlay between each other.

Moreover, in the above exemplary embodiment and modified examples, examples have been given in which imaging is performed rearward from the vehicle for visual recognition of the vehicle surroundings to the rear of the vehicle. However, there is no limitation thereto, and a mode may be applied in which visual recognition is performed ahead of the vehicle, or a mode may be applied in which visual recognition is performed at the vehicle sides.

Moreover, explanation has been given in which the processing performed by the control device 30 in the exemplary embodiment and the modified examples described above is software-based processing. However, there is no limitation thereto. For example, the processing may be hardware-based processing, or the processing may be a combination of both hardware and software-based processing.

Moreover, the processing performed by the control device 30 of the above exemplary embodiment may be stored and distributed as a program on a recording medium.

Furthermore, the present invention is not limited to the above description, and obviously various other modifications may be implemented within a range not departing from the spirit of the present invention.

The disclosure of Japanese Patent Application No. 2017-158735, filed on Aug. 21, 2017, is incorporated in its entirety by reference herein.

1. A vehicular visual recognition device comprising:
two or more imaging sections provided at different positions and configured to image surroundings of a vehicle; and
a display section configured to display a composite image merging captured images captured by the two or more imaging sections and to display a blind spot advisory image to advise of a blind spot in the composite image.

2. The vehicular visual recognition device of claim 1, wherein the display section is configured to display the blind spot advisory image alongside the composite image.

3. The vehicular visual recognition device of claim 1, wherein the display section is configured to display the blind spot advisory image within the composite image.

4. The vehicular visual recognition device of claim 1, further comprising a change section configured to:
change a merging position of the composite image displayed on the display section in response to at least one vehicle state of vehicle speed, turning or reversing; and
change the blind spot advisory image in response to a change to the merging position.

5. The vehicular visual recognition device of claim 1, wherein:
the two or more imaging sections correspond to door imaging sections respectively provided at left and right doors of the vehicle, and to a rear imaging section provided at a vehicle width direction central portion of a rear section of the vehicle; and
the display section is provided at an interior mirror.
